(19) United States
(12) Patent Application Publication
(10) Pub. No.: US 2025/0060939 A1
(43) Pub. Date: Feb. 20, 2025

(54) IN-MEMORY COMPUTING DEVICES FOR MULTIPLY ACCUMULATE

(71) Applicant: Apple Inc., Cupertino, CA (US)

(72) Inventors: Yildiz SINANGIL, Cupertino, CA (US); Lei WANG, Cupertino, CA (US); Michael L LIU, Cupertino, CA (US); Jaewon SHIN, Cupertino, CA (US)

(73) Assignee: Apple Inc., Cupertino, CA (US)

(21) Appl. No.: 18/452,373

(22) Filed: Aug. 18, 2023

(51) Int. Cl. G06F 7/544

(52) U.S. Cl. CPC G06F 7/5443

(57) ABSTRACT

The present disclosure describes an in-memory computing (IMC) circuit including a first set of IMC cells having a first number of IMC cells and a second set of IMC cells having the first number of IMC cells. The first set of IMC cells can generate a first bit-product of a weight number having a first number of bits and a first bit of an input number having a second number of bits. The second set of IMC cells can generate a second bit-product of the weight number and a second bit of the input number. A first IMC cell of the first set of IMC cells includes a first bit-wise multiplication circuit configured to multiply a first bit of the weight number and the first bit of the input number.

### FIELD

The present disclosure relates to in-memory computing (IMC) circuits, devices, and systems.

### BACKGROUND

Many applications, such as Artificial intelligence (AI) and machine learning algorithms, and image signal processing, rely on matrix multiplications that have many multiplication and addition operations, which can be referred to as multiply accumulate (MAC) operations. The MAC operations can be performed by software or hardware, such as circuits and devices. In-memory computing (IMC) is a technology that uses memory devices in a hardware system to execute MAC operations.

### SUMMARY

Embodiments of the present disclosure include a system having an in-memory computing (IMC) circuit to perform multiply accumulate (MAC) operations of a weight number with one or more input numbers. The weight number can have a first number of bits and an input number can have a second number of bits. The IMC circuit can generate a product or a partial product of the weight number and the input number. In some embodiments, all the bits of the input number can be provided to the IMC circuit in parallel. In addition, the same weight number can be applied to a plurality of input numbers each having the second number of bits.

Embodiments of the present disclosure include a device or an IMC circuit including a first set of IMC cells having a first number of IMC cells and a second set of IMC cells having the first number of IMC cells. The first set of IMC cells can be configured to generate a first bit-product of a weight number having the first number of bits and a first bit of an input number having a second number of bits. Similarly, the second set of IMC cells can be configured to generate a second bit-product of the weight number and a second bit of the input number. A first IMC cell of the first set of IMC cells includes a first bit-wise multiplication circuit configured to multiply a first bit of the weight number and the first bit of the input number, and a second IMC cell of the second set of IMC cells includes a second bit-wise multiplication circuit configured to multiply a second bit of the weight number and the second bit of the input number.

In some embodiments, the first IMC cell includes a first memory cell configured to store the first bit of the weight number, and where the first IMC cell is coupled to a second memory cell configured to store the first bit of the input number. The first memory cell or the second memory cell can include a static random-access memory (SRAM) cell. The first bit-wise multiplication circuit or the second bit-wise multiplication circuit can include one or more of a NOR gate and a NAND gate. In some embodiments, the first bit of the weight number stored in the first memory cell can be coupled to an other IMC cell of the second set of IMC cells to provide the first bit of the weight number to the other IMC cell so that content of the first memory cell of the first IMC cell can be shared by the other IMC cell of the second set of IMC cells.

In some embodiments, the first bit-wise multiplication circuit can be configured to receive the first bit of the input number, and the second bit-wise multiplication circuit can be configured to receive the second bit of the input number. In some embodiments, the first bit of the input number and the second bit of the input number can be selected from a set of Booth encoded bits of the input number.

In some embodiments, the device can further include a first set of shifters and a second set of shifters. The first set of shifters can be coupled to the first set of IMC cells and configured to shift the first bit-product by a first position to generate a first shifted bit-product, and the second set of shifters can be coupled to the second set of IMC cells and configured to shift the second bit-product by a second position to generate a second shifted bit-product. In some embodiments, a multiple-bit adder can be coupled to the first set of shifters and the second set of shifters and configured to add the first shifted bit-product and the second shifted bit-product to generate a partial product of a product of the weight number and the input number.

In some embodiments, the input number can be a first input number received by the first set of IMC cells and the second set of IMC cells at a first time instance. In addition, the first set of IMC cells can be further configured to generate a third bit-product of the weight number and a first bit of a second input number having the second number of bits received at a second time instance after the first time instance. The second set of IMC cells can be configured to generate a fourth bit-product of the weight number and a second bit of the second input number received at the second time instance. In some embodiments, the first set of IMC cells and the second set of IMC cells can be configured to receive the first input number and the second input number, respectively, at a double pumped speed. In some embodiments, a third IMC cell of the first set of IMC cells can include a third bit-wise multiplication circuit configured to multiply a third bit of the weight number and the first bit of the second input number, and a fourth IMC cell of the second set of IMC cells can include a fourth bit-wise multiplication circuit configured to multiply a fourth bit of the weight number and the second bit of the second input number.

In some embodiments, a memory circuit can include a set of memory cells configured to store a weight number having a first number of bits and a control circuit configured to provide an input number to an IMC circuit, where the input number has a second number of bits. The memory circuit can further include the IMC circuit with a matrix of IMC cells having a total number of IMC cells configured to receive in parallel the second number of bits of the input number and perform bit-wise multiplications in parallel, where the total number is a product of the first number and the second number. An IMC cell of the matrix of IMC cells can include a bit-wise multiplication circuit configured to multiply a first bit of the input number and a second bit of the weight number. In some embodiments, the bit-wise multiplication circuit can include one or more of a NOR gate and a NAND gate. In some embodiments, the IMC cell can include a memory cell configured to store the second bit of the weight number, the IMC cell can be coupled to an other memory cell configured to store the first bit of the input number, and the memory cell can include a static random-access memory (SRAM) cell.

In some embodiments, the matrix of IMC cells can be configured to generate the second number of bit-products including a first bit-product and a second bit-product. The first bit-product can be generated by a first set of IMC cells for a product of the first bit of the input number multiplied with the weight number. The second bit-product can be generated by a second set of IMC cells for a product of a second bit of the input number multiplied with the weight number.

In some embodiments, the first set of IMC cells can be coupled to a first set of shifters configured to shift the first bit-product by a first position to generate a first shifted bit-product, and the second set of IMC cells can be coupled to a second set of shifters configured to shift the second bit-product by a second position to generate a second shifted bit-product. In some embodiments, the first set of shifters and the second set of shifters can be included in the memory circuit. In some embodiments, the first set of shifters and the second set of shifters can be coupled to a multiple-bit adder and configured to add the first shifted bit-product and the second shifted bit-product to generate a partial product of a product of the weight number and the input number.

In some embodiments, a method can include generating, by a bit-wise multiplication circuit, a bit-wise product by multiplying a bit of a weight number having a first number of bits and a bit of an input number having a second number of bits. The method can further include generating, by a first set of IMC cells, a first bit-product of the weight number and a first bit of the input number, where the first bit-product includes the first number of bits, a bit of the first bit-product includes a first bit-wise product generated by a first bit-wise multiplication circuit. In addition, the method can include generating, by a second set of IMC cells including the first number of IMC cells, a second bit-product of the weight number and a second bit of the input number, where the second bit-product includes the first number of bits and a bit of the second bit-product includes a second bit-wise product generated by a second bit-wise multiplication circuit.

In some embodiments, the method can further include shifting, by a first set of shifters coupled to the first set of IMC cells, the first bit-product by a first position to generate a first shifted bit-product; shifting, by a second set of shifters coupled to the second set of IMC cells, the second bit-product by a second position to generate a second shifted bit-product; and generating, by a multiple-bit adder coupled to the first set of shifters and the second set of shifters, a sum of the first shifted bit-product and the second shifted bit-product as a partial product of a product of the weight number and the input number.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is an illustration of an electronic system including a memory circuit having an in-memory computing (IMC) circuit to perform multiply accumulate (MAC) operations, according to some embodiments.

FIGS. 2A-2C are illustrations of IMC circuits that perform two-bit MAC operations, according to some embodiments.

FIGS. 3A-3B are illustrations of IMC circuits that perform multiple-bit MAC operations, according to some embodiments.

FIG. 4 is an illustration of IMC circuits that perform multiple-bit MAC operations, according to some embodiments.

FIG. 5 is an illustration of a method performing multiple-bit MAC operations by an IMC circuit, according to some embodiments.

FIG. 6 is an illustration of exemplary systems or devices that can include the disclosed embodiments.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

Multiplication of two matrices can require a large number of multiplications and additions of numbers, which can be referred to as multiply accumulate (MAC) operations. The MAC operations can include a multiplication of two numbers, such as a weight number W of a first number of bits denoted by an integer i, W=Wᵢ . . . W₁W₀, and an input number P of a second number of bits denoted by an integer j, P=Pⱼ . . . P₁P₀, where W and P represent binary numbers. In some embodiments, W=Wᵢ . . . W₁W₀ and P=Pⱼ . . . P₁P₀ can represent an integer, a pseudo floating point, a signed integer, an unsigned integer, or a number of other format of various number of bits. In some embodiments, the weight number W=Wᵢ . . . W₁W₀ or the input number P=Pⱼ . . . P₁P₀ can be 2 bits, 4 bits, 8 bits, 16 bits, or other suitable number of bits. In some embodiments, a two bit number, such as a two bit weight number W=W₁W₀, can be used as an example to illustrate various techniques presented herein. However, any description for a two bit weight number W=W₁W₀ can be applicable to a weight number of different number of bits.

To generate a product W*P=Wᵢ . . . W₁W₀*Pⱼ . . . P₁P₀, a unit of operation can include a bit-wise multiplication circuit to generate a bit-wise product W*Pₜ by multiplying Wₛ, a bit of the weight number W selected from Wᵢ, . . . , W₁, W₀, and Pₜ, a bit of the input number P selected from P, . . . P₁, P₀. The bit-wise multiplication circuit can be implemented in various ways, including an analog circuit or a digital circuit. In addition, the bit-wise multiplication circuit can be included in an in-memory computing (IMC) circuit within a memory circuit or a circuit outside of the memory circuit.

To multiply W=Wᵢ . . . W₁W₀ with P=Pⱼ . . . P₁P₀, an IMC circuit including multiple IMC cells may be used to generate the bit-wise product W*Pₜ, where Wₛ=Wᵢ, . . . , W₁, W₀ and Pₜ=Pⱼ, . . . P₁P₀. In some embodiments, a total number N=i*j of IMC cells can be used, where each IMC cell can include a bit-wise multiplication circuit to generate bit-wise product W*Pₜ. To multiply the input number P=Pⱼ . . . P₁P₀ with the weight number W=Wᵢ . . . W₁W₀, the bits Pⱼ . . . P₁, P₀ of input number P=Pⱼ . . . P₁P₀ can be supplied to a set of IMC cells in a bit-serial fashion where the bits Pⱼ . . . P₁, P₀ arrive in sequence over time in multiple clock cycles (e.g., one bit per unit of time or per clock cycle). Additionally and alternatively, bits Pⱼ . . . P₁P₀, P₀ of the input number P=Pⱼ . . . P₁P₀ can be supplied to a set of IMC cells in a parallel fashion, where the bits Pⱼ . . . . P₀, P₀ arrive in parallel during the same clock cycle.

The embodiments herein present designs for a memory circuit including an IMC circuit to perform MAC operations including the operations defined above. In some embodiments, a memory circuit can include a set of memory cells configured to store the weight number W=Wᵢ . . . W₁W₀ having the first number of bits and a control circuit configured to provide the input number P=Pⱼ . . . P₁P₀ to the IMC circuit, where the input number P=Pⱼ . . . P₁P₀ has a second number of bits. The memory circuit can further include the IMC circuit including a matrix of IMC cells having a total number N=i*j of IMC cells configured to receive in parallel the second number of bits of the input number P=Pⱼ . . . P₁P₀ and perform N=i*j bit-wise multiplications in parallel. An IMC cell of the matrix of IMC cells can include a bit-wise multiplication circuit configured to multiply a first bit Pₜ of the input number P=Pⱼ . . . P₁P₀ and a second bit Wₛ of weight number W=Wᵢ . . . W₁W₀ to generate the bit-wise product W*Pₜ. In some embodiments, the bit-wise multiplication circuit can include a NOR gate or a NAND gate. When implemented within the IMC circuit, the NOR gate or the NAND gate can be implemented by a few transistors, such as less than 10 transistors. In some embodiments, the IMC cell can include a memory cell configured to store the second bit Wₛ of the weight number W, the IMC cell can be coupled to an other memory cell configured to store the first bit Pₜ of the input number P=Pⱼ . . . P₁P₀, and the memory cell can include a static random-access memory (SRAM) cell, a magnetoresistive random-access memory (MRAM) cell, any other suitable type of non-volatile random-access memory (NVRAM), or any other suitable type of memory.

In some embodiments, there can be multiple input numbers, which can be denoted as P₀, . . . , Pₖ, where each input number can have j bits. Therefore, the input numbers can be denoted as P₀=P₀ⱼ . . . P₀₁P₀₀, P₁=P₁₁ . . . P₁₁P₁₀, . . . Pₖ=Pₖⱼ . . . Pₖ₁Pₖ₀. Embodiments herein can calculate a product of W=Wᵢ . . . W₁W₀ with any of the input numbers, such as P₀, . . . , Pₖ, to derive P₀*W, . . . , Pₖ*W, and may further add the products to derive a sum of product S=P₀*W+ . . . +Pₖ*W. The MAC operations described herein can include all operations to derive the sum of product S=P₀*W+ . . . +Pₖ*W.

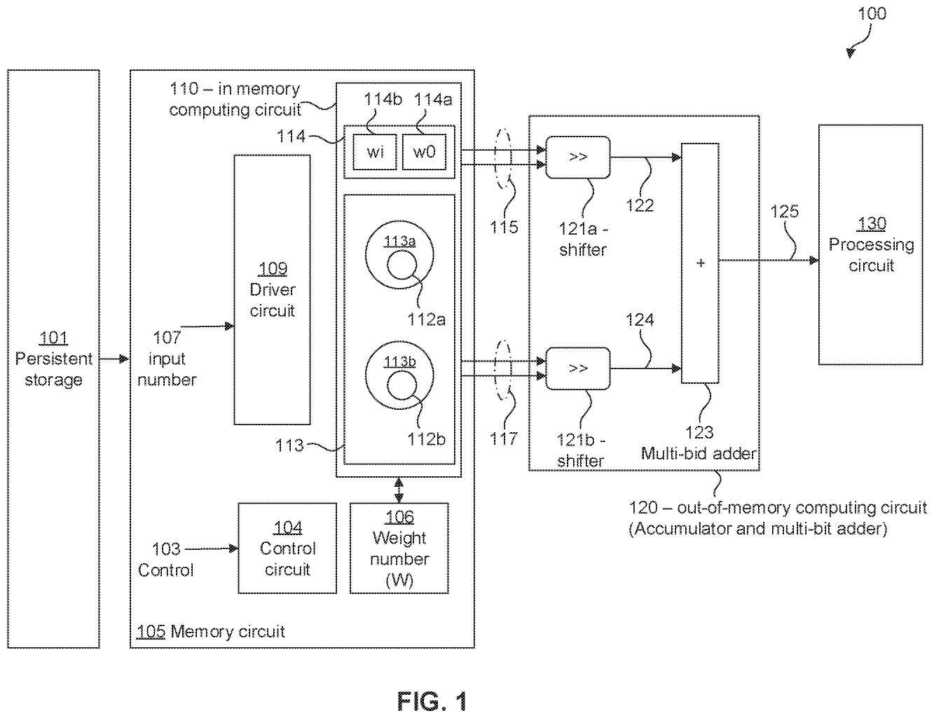

FIG. 1 is an illustration of an electronic system 100 including a memory circuit 105 having an IMC circuit 110 to perform MAC operations, according to some embodiments. In some embodiments, the MAC operations performed may include operations for the multiplication of the weight number W=Wᵢ . . . W₁W₀ and the input number=Pⱼ . . . P₁P₀, where W*P=Wᵢ . . . W₁W₀*Pⱼ . . . P₁P₀ or S=P₀*W+ . . . +Pₖ*W. Electronic system 100 can also be referred to herein as a system, a circuit, or a device.

In some embodiments, system 100 can include a memory circuit 105 coupled to an out-of-memory computing block 120 to work together with IMC circuit 110 to perform MAC operations. Out-of-memory computing block 120 may be further coupled to a processing circuit 130 to provide the result of MAC operations to other applications. In some embodiments, processing circuit 130 may include an arithmetic logic unit (ALU), such as an ALU used in a processor. In addition, memory circuit 105 can be coupled to a persistent storage device 101 where input numbers, such as P=Pⱼ . . . P₁P₀, P₀=P₀ⱼ . . . P₀₁P₀₀, P₁=P₁ⱼ . . . P₁₁P₁₀, Pₖ=Pₖⱼ . . . Pₖ₁Pₖ₀, or the weight number W=Wᵢ . . . W₁W₀, may be initially stored.

In some embodiments, memory circuit 105 can include IMC circuit 110 coupled to a driver circuit 109 and a control circuit 104. IMC circuit 110 can include a set 114 of memory cells having memory cells 114a, 114b, or more configured to store the weight number W=Wᵢ . . . W₁W₀ having a first number of bits, and a set 113 of IMC cells including an IMC cell 113a, an IMC cell 113b, or more. Each IMC cell can include a bit-wise multiplication circuit. For example, IMC cell 113a includes a bit-wise multiplication circuit 112a to generate a bit-wise product W*Pₜ by multiplying a bit Wₛ of weight number W=Wᵢ . . . W₁W₀ and a bit Pₜ of input number P=Pⱼ . . . P₁P₀. In addition, IMC cell 113b includes a bit-wise multiplication circuit 112b. In some embodiments, the input number P=Pⱼ . . . P₁P₀ can be supplied as input number 107, and the weight number W=Wᵢ . . . W₁W₀ can be provided as a weight number 106 that can be saved into set 114 of memory cells. A control signal 103 can be provided to control circuit 104 to control driver circuit 109 to provide input number 107 to IMC circuit 110 by controlling the activation of driver circuit 109.

In some embodiments, IMC circuit 110 can include a matrix of IMC cells 113 having a total number N=i*j of IMC cells 113 configured to receive in parallel the second number j of bits of the input number P=Pⱼ . . . P₁P₀ and perform bit-wise multiplications in parallel to generate a bit-wise product W*Pₜ. An IMC cell, such as IMC cell 113a, can include a bit-wise multiplication circuit, such as bit-wise multiplication circuit 112a, configured to multiply a first bit Pₜ of the input number P=Pⱼ . . . P₁P₀ and a second bit Wₛ of the weight number W=Wᵢ . . . W₁W₀. In some embodiments, bit-wise multiplication circuit 112a or 112b can include a NOR gate or a NAND gate. When implemented within IMC circuit 110, the NOR gate or the NAND gate can be implemented by a few transistors, such as 4 transistors. The small number of transistors used to implement the NOR gate or NAND gate can make the bit-wise multiplication circuit compact and economic to be included in IMC circuit 110, according to some embodiments. In some embodiments, IMC cell 113a can include a memory cell configured to store the second bit Wₛ of the weight number. IMC cell 113a can be coupled to an other memory cell configured to store the first bit Pₜ of the input number P=Pⱼ . . . P₁P₀. The memory cells can include a static random-access memory (SRAM) cell, such as a 6T SRAM cell.

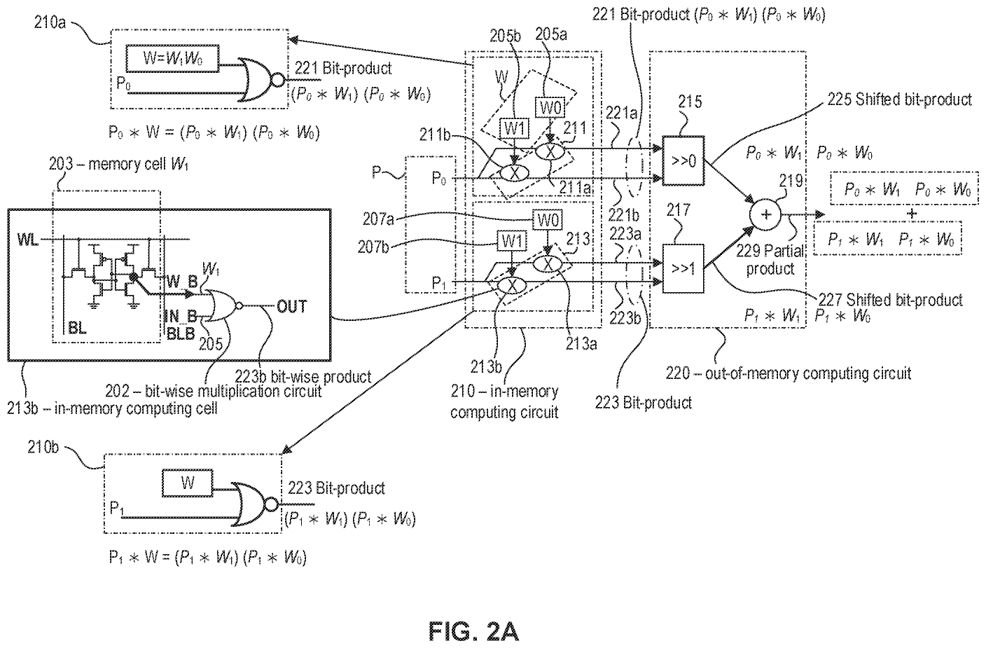

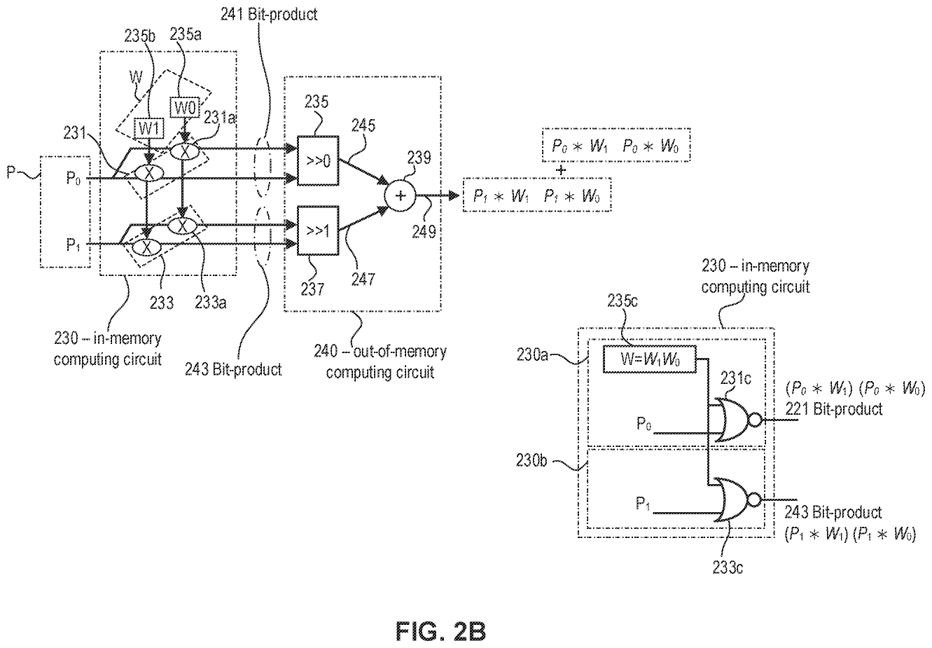

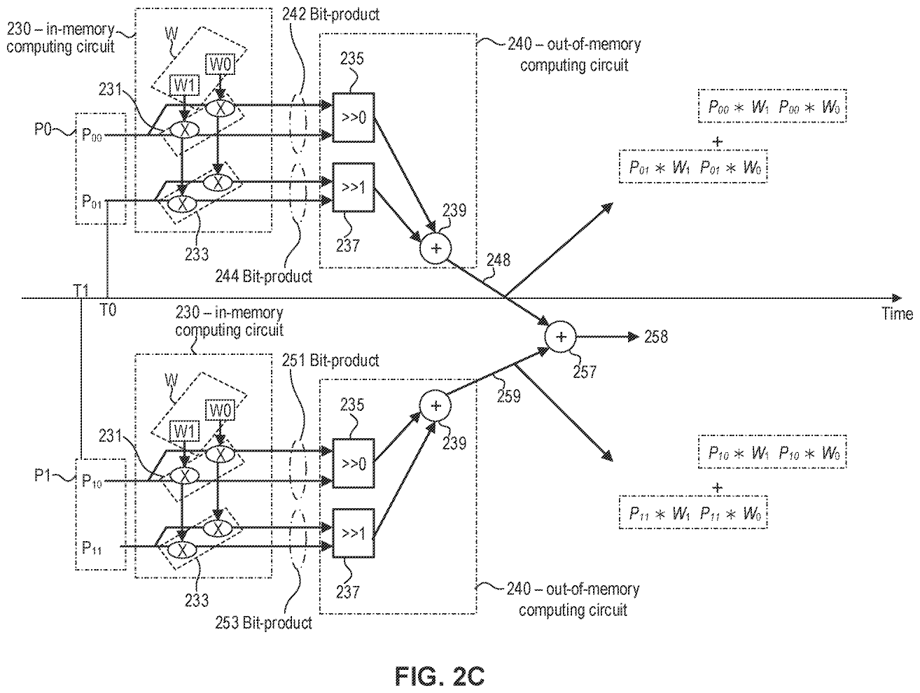

In some embodiments, the matrix of IMC cells can be configured to generate the second number of bit-products including a first bit-product 115 and a second bit-product 117. First bit-product 115 can be generated by a first set of IMC cells for a product of the first bit Pₜ₁ of the input number P=Pⱼ . . . P₁P₀ multiplied with the weight number W=Wᵢ . . . W₁W₀. Hence, first bit-product 115 has a value of (Pₜ₁*Wᵢ) . . . (Pₜ₁*W₁) (Pₜ₁*W₀). Second bit-product 17 can be generated by a second set of IMC cells for a product of a second bit Pₜ₂ of the input number P=Pⱼ . . . P₁P₀ multiplied with the weight number W=Wᵢ . . . W₁W₀, which can have a value of (Pₜ₂*Wᵢ) . . . (Pₜ₂*W₁) (Pₜ₂*W₀). Overall, there can be total j such bit-products generated for each bit of the input number P=Pⱼ . . . P₁P₀. Each bit-product can be generated by a bit-product circuit with more details shown in FIGS. 2A-2C, 3A-3B, and 4.

In some embodiments, the first set of IMC cells can be coupled to a first set 121a of shifters configured to shift first bit-product 115 by a first position to generate a first shifted bit-product 122, and the second set of IMC cells can be coupled to a second set 121b of shifters configured to shift second bit-product 117 by a second position to generate a second shifted bit-product 124. The first position and the second position may have different integer values. First set 121a of shifters or second set 121b of shifters can include total i shifters corresponding to the number of bits of the bit-product, such as first bit-product 115 or second bit-product 117. In some embodiments, first set 121a of shifters and second set 121b of shifters can be included in memory circuit 105. In some embodiments, first set 121a of shifters and second set 121b of shifters can be coupled to a multiple-bit adder 123 and configured to add first shifted bit-product 122 and second shifted bit-product 124 to generate a partial product 125 of a product of the weight number W=Wᵢ . . . W₁W₀ and the input number P=Pⱼ . . . P₁P₀. Multiple-bit adder 123 can be implemented in various way, including a multi-level adder tree of different adders.

FIGS. 2A-2C are illustrations of IMC circuits to perform two-bit MAC operations, according to some embodiments. FIG. 2A illustrates an IMC circuit 210 coupled to an out-of-memory computing block 220 to perform MAC operations to generate a product of a weight number W=W₁W₀ and an input number P=P₁P₀. Hence, the product generated has a value of W*P=W₁W₀*P₁P₀. IMC circuit 210 and out-of-memory computing block 220 can be examples of IMC circuit 110 and out-of-memory computing block 120 shown in FIG. 1. IMC circuit 210 and out-of-memory computing block 220 are presented for two-bit numbers to generate the product of W*P=W₁W₀*P₁P₀. The circuits, including IMC circuit 210 and out-of-memory computing block 220, can be expanded to perform MAC operations to generate a product of W*P=Wᵢ . . . W₁W₀*Pⱼ . . . P₁P₀.

In some embodiments, IMC circuit 210 can include a first set 211 of IMC cells having a first IMC cell 211a and a second IMC cell 211b and can also include a second set 213 of IMC cells having a first IMC cell 213a and a second IMC cell 213b. For a weight number W=Wᵢ . . . W₁W₀, first set 211 or second set 213 of IMC cells can have i cells corresponding to the number of bits in the weight number W. First set 211 of IMC cells can generate a first bit-product 221 of the weight number W=W₁W₀ and a first bit P₀ of the input number P=P₁P₀. The value of the weight number W=W₁W₀ can be saved in memory cells 205a, 205b, respectively. First bit-product 221 can have a first bit 221a with a value of P₀*W₀ and can have a second bit 221b with a value of P₀*W₁. First bit-product 221 can have i bits corresponding to the number of bits in the weight number W. A bit of first bit-product 221 can have a value of P₀*Wₛ, where W_{S} can be a bit of the weight number W=Wᵢ . . . W₁W₀.

Similarly, second set 213 of IMC cells can generate a second bit-product 223 of the weight number W=W₁W₀ and a second bit P¹ of the input number P=P₁P₀. Second bit-product 223 can have a first bit 223a with a value of Pᵢ*W₀ and a second bit 223b with a value of P₁*W₁. The value of the weight number W=W₁W₀ can be saved in memory cells 207a, 207b, respectively.

In some embodiments, memory cells 205a, 205b used to store the weight number W=W₁W₀ together with first set 211 of IMC cells used to generate first bit-product 221 can form a bit-product circuit 210a, which is configured to receive a bit P₀ of the input number P=P₁P₀, and to multiply P₀ with the weight number W=W₁W₀ to generate first bit-product 221 having a value of (P₀*W₁)(P₀*W₀). Similarly, memory cells 207a, 207b used to store the weight number W=W₁W₀ together with second set 213 of IMC cells used to generate second bit-product 223 can form a bit-product circuit 210b, which is configured to receive a bit P₁ of the input number P=P₁P₀, and to multiply Pᵢ with the weight number W=W₁W₀ to generate second bit-product 223 having a value of (P₁*W₁)(P₁*W₀).

In some embodiments, an IMC cell, such as IMC cell 211a, IMC cell 211b, IMC cell 213a, and IMC cell 213b, can include a bit-wise multiplication circuit configured to multiply a bit of the weight number and a bit of the input number. For example, IMC cell 213b can include a bit-wise multiplication circuit 202, which is a NOR gate that is configured to multiply Pᵢ and W₁. IMC cell 213b can receive a first bit P₁ of the input number P=P₁P₀ at an input line 205. IMC cell 213b can include a memory cell 203 configured to store W₁ of the weight number W=W₁W₀, and where IMC cell 213b is coupled to a memory cell configured to store Pᵢ through input line 205. Memory cell 203 or the memory cell used to store P₁ can include a SRAM cell, such as a 6 transistor SRAM cell. In some embodiments, bit-wise multiplication circuit 202 can include a NOR gate or a NAND gate, which can be implemented by 4 transistors. Accordingly, bit-wise multiplication circuit 202 is a digital bit-wise multiplication circuit instead of an analog multiplication circuit. In addition, bit-wise multiplication circuit 202 is directly coupled to the output line of memory cell 203. In comparison with placing a bit-wise multiplication circuit away from memory cell 203, embodiments herein can reduce the time needed for the output of memory cell 203 to travel to the bit-wise multiplication circuit placed elsewhere. Accordingly, the direct connection between the output line of memory cell 203 and bit-wise multiplication circuit 202 can improve the performance of IMC circuit 210 and the performance of MAC operations.

In some embodiments, out-of-memory computing block 220 can include a first set 215 of shifters and a second set 217 of shifters. First set 215 of shifters can be coupled to first set 211 of IMC cells and configured to shift first bit-product 221 by a first position to generate a first shifted bit-product 225. Second set 217 of shifters can be coupled to second set 213 of IMC cells and configured to shift second bit-product 223 by a second position to generate a second shifted bit-product 227. In some embodiments, the first position and the second position being shifted have different values, and the first position can have value 0, which means the first shifted bit-product 225 is not shifted and has the same value as first bit-product 221.

In some embodiments, a multiple-bit adder 219 can be coupled to first set 215 of shifters and second set 217 of shifters and configured to add first shifted bit-product 225 and second shifted bit-product 227 to generate a product 229 of the weight number W=W₁W₀ and the input number P=P₁P₀, which has a value of [2(P₁*Wᵢ)(P₁*W₀)]+(P₀*W₁)(P₀*W₀).

In some embodiments, some or all of first set 215 of shifters and second set 217 of shifters, as well as multiple-bit adder 219, can be included in a memory circuit, such as memory circuit 105. By including first set 215 of shifters, second set 217 of shifters, or multiple-bit adder 219 into the memory circuit, the speed of the MAC operations can be improved. Hence, there can be different embodiments that can implement the designs shown in FIG. 2A. A multiplication circuit to multiply two numbers, such as the weight number W=W₁W₀ and the input number P=P₁P₀, may use shifters. However, other designs may place the shifters in different locations. In some embodiments, by placing first set 215 of shifters, second set 217 of shifters, or multiple-bit adder 219 outside IMC circuit 210, the cost of IMC circuit 210 can be reduced. In some embodiments, IMC 210 and out-of-memory computing block 220 may be manufactured on the same semiconductor substrate or placed on the same chip. In some other embodiments, IMC 210 and out-of-memory computing block 220 may be manufactured on different semiconductor substrates or placed on different chips.

FIG. 2B illustrates IMC circuit 230 coupled to an out-of-memory computing block 240 to perform MAC operations to generate a product W*P=W₁W₀*P₁P₀, according to some embodiments. IMC circuit 230 and out-of-memory computing block 240 can be examples of IMC circuit 110 and out-of-memory computing block 120 shown in FIG. 1. In addition, IMC circuit 230 differs from IMC circuit 210 by the way the weight number W=W₁W₀ is stored and provided to a set of IMC cells to produce a bit-product. Out-of-memory computing block 240 can be the same as out-of-memory computing block 220.

In some embodiments, IMC circuit 230 is coupled to out-of-memory computing block 240 to perform MAC operations to generate a product of a weight number W=W₁W₀ and an input number P=P₁P₀. IMC circuit 230 can include a first set 231 of multiple IMC cells and a second set 233 of multiple IMC cells. First set 231 of multiple IMC cells are configured to receive a bit P₀ of the input number P=P₁P₀ and to multiply P₀ with the weight number W=W₁W₀ to generate first bit-product 241 having a value of (P₀*W₁)(P₀*W₀). The value of the weight number W=W₁W₀ can be saved in memory cells 235a, 235b, respectively. Similarly, second set 233 of multiple IMC cells are configured to receive a bit P₁ of the input number P=P₁P₀, and to multiply Pᵢ with the weight number W=W₁W₀ to generate second bit-product 243 having a value of (P₁*W₁)(P₁*W₀). Instead of having separated memory cells to store the weight number W=W₁W₀ for second set 233 of multiple IMC cells, second set 233 of multiple IMC cells share the weight number W=W₁W₀ stored in memory cells 235a, 235b. Accordingly, W₀ is stored in memory cell 235a, coupled to an IMC cell 231a of first set 231 of multiple IMC cells to generate first bit-product 241, and also coupled to another IMC cell 233a of second set 233 of IMC cells to provide the first bit W₀ of the weight number W=W₁W₀ to IMC cell 233a so that the content of memory cell 235a can be shared by IMC cell 233a of second set 233 of IMC cells. By sharing the content of memory cell 235a, IMC circuit 230 can save chip area and reduce cost.

In some embodiments, out-of-memory computing block 240 can include a first set 235 of shifters and a second set 237 of shifters. First set 235 of shifters can be coupled to first set 231 of IMC cells and configured to shift first bit-product 241 by a first position to generate a first shifted bit-product 245. Second set 237 of shifters can be coupled to second set 233 of IMC cells and configured to shift second bit-product 243 by a second position to generate a second shifted bit-product 247. In some embodiments, a multiple-bit adder 239 can be coupled to first set 235 of shifters and second set 237 of shifters and configured to add first shifted bit-product 245 and second shifted bit-product 247 to generate a product 249 of the weight number W=W₁W₀ and the input number P=P₁P₀, which has of value of [2(P₁*Wᵢ)(P₁*W₀)]+(P₀*Wᵢ)(P₀*W₀).

For simplicity, a symbol 231c is used to represent first set 231 of IMC cells and a symbol 233c is used to represent second set 233 of IMC cells. First set 231 of IMC cells and second set 233 of IMC cells can be coupled to memory cells 235a and 235b, which is represented by memory cells symbol 235c. Memory cells represented by symbol 235c together with symbol 231c representing first set 231 of IMC cells can form a bit-product circuit 230a to generate first bit-product 241. Accordingly, bit-product circuit 230a can be configured to receive a bit P₀ of the input number P=P₁P₀, and to multiply P₀ with the weight number W=W₁W₀ to generate first bit-product 241 having a value of (P₀*W₁)(P₀*W₀). Similarly, memory cells represented by symbol 235c together with symbol 233c representing second set 233 of IMC cells can form a bit-product circuit 230b to generate second bit-product 243, which is configured to receive a bit P₁ of the input number P=P₁P₀, and to multiply P₁ with the weight number W=W₁W₀ to generate second bit-product 243 having a value of (P₁*W₁)(P₁*W₀).

FIG. 2C illustrates IMC circuit 230 coupled to out-of-memory computing block 240 to perform MAC operations to generate a sum of products S=P₀*W+Pᵢ*W=(P₀₀P₀₀)*(W₁W₀)+(P₁₁P₁₀)*(W₁W₀), using the same circuits shown in FIG. 2B, according to some embodiments.

In some embodiments, at a first time instance T0, input number P₀=P₀₁P₀₀ can be received by first set 231 of IMC cells and second set 233 of IMC cells.

First set 231 of multiple IMC cells can receive a bit P₀₀ of the input number P₀=P₀₁P₀₀, and to multiply P₀₀ with the weight number W=W₁W₀ to generate first bit-product 242 having a value of (P₀₀*W₁)(P₀₀*W₀). Similarly, second set 233 of multiple IMC cells can receive a bit P₀₁ of the input number P₀=P₀₁P₀₀, and to multiply P₀ₗ with the weight number W=W₁W₀ to generate second bit-product 244 having a value of (P₀₁*W₁)(P₀₁*W₀).

In some embodiments, out-of-memory computing block 240 can include a first set 235 of shifters and a second set 237 of shifters. First set 235 of shifters can be coupled to first set 231 of IMC cells and configured to shift first bit-product 242 by a first position to generate a first shifted bit-product. Second set 237 of shifters can be coupled to second set 233 of IMC cells and configured to shift second bit-product 244 by a second position to generate a second shifted bit-product. In some embodiments, a multiple-bit adder 239 can be coupled to first set 235 of shifters and second set 237 of shifters and can be configured to add the first shifted bit-product and the second shifted bit-product to generate a product 248 of the weight number W=W₁W₀ and the input number P₀=P₀₁P₀₀, which has a value of [2(P₀₁*W₁)(P₀₁*W₀)]+(P₀₀*W₀)(P₀₀*W₀).

In some embodiments, at a second time instance T1 after the first time instance T0, input number P₁=P₁₁P₁₀ can be received by first set 231 of IMC cells and second set 233 of IMC cells. In some embodiments, first set 231 of IMC cells and second set 233 of IMC cells can be configured to receive input number P₀=P₀₁P₀₀ and input number Pᵢ=P₁₁P₁₀, respectively, at a double pumped speed. In some embodiments, data is provided at a double pumped speed when the data is provided on both rising and falling edges of a clock signal.

In some embodiments, at the second time instance T1, first set 231 of multiple IMC cells can receive a bit P₁₀ of the input number P₁=P₁₁P₁₀ and multiply P₁₀ with the weight number W=W₁W₀ to generate first bit-product 251 having a value of (P₀*Wᵢ)(P₁₀*W₀). Similarly, second set 233 of multiple IMC cells can receive a bit P₁₁ of the input number Pᵢ=P₁₁P₁₀, and to multiply P₁₁ with the weight number W=W₁W₀ to generate second bit-product 253 having a value of (P₁₁*W₁)(P₁*W₀). While generated by the same IMC circuit 230, first bit-product 251 generated at the second time instance T1 can be different from first bit-product 242 generated at the first time instance T0, because the input bits are different at the two time instances.

In some embodiments, first set 235 of shifters can shift first bit-product 251 by a first position to generate a first shifted bit-product, and second set 237 of shifters can shift second bit-product 253 by a second position to generate a second shifted bit-product. In some embodiments, a multiple-bit adder 239 can be coupled to first set 235 of shifters and second set 237 of shifters and configured to add the first shifted bit-product and the second shifted bit-product to generate a product 259 of the weight number W=W₁W₀ and the input number P₁=P₁₁P₁₀, which has a value of [2(P₁₁*Wᵢ)(P₁₁*W₀)]+(P₁₀*W₁)(P₁₀*W₀).

In addition, an adder 257 can be used to add product 259 and product 248 together to generate a sum 258. In some embodiments, adder 257 can be the same adder 239 acting as an adder and accumulator that can save the previous value of the addition operation, product 248, to add a new value, product 259, to the previous value product 248. In some embodiments, adder 257 and adder 239 can be implemented in various ways, such as a single multi-bit adder or a collection of adders forming an adder tree. The value of sum 258 has a value of P₀*W+P₁*W=(P₀₁P₀₀)*(W₁W₀)+(P₁P₁₀)*(W₁W₀).

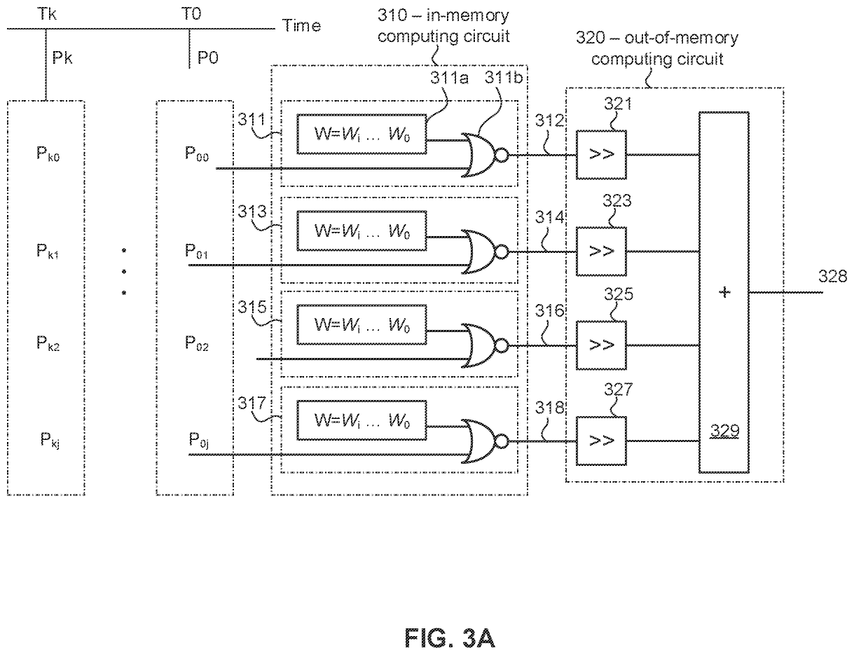

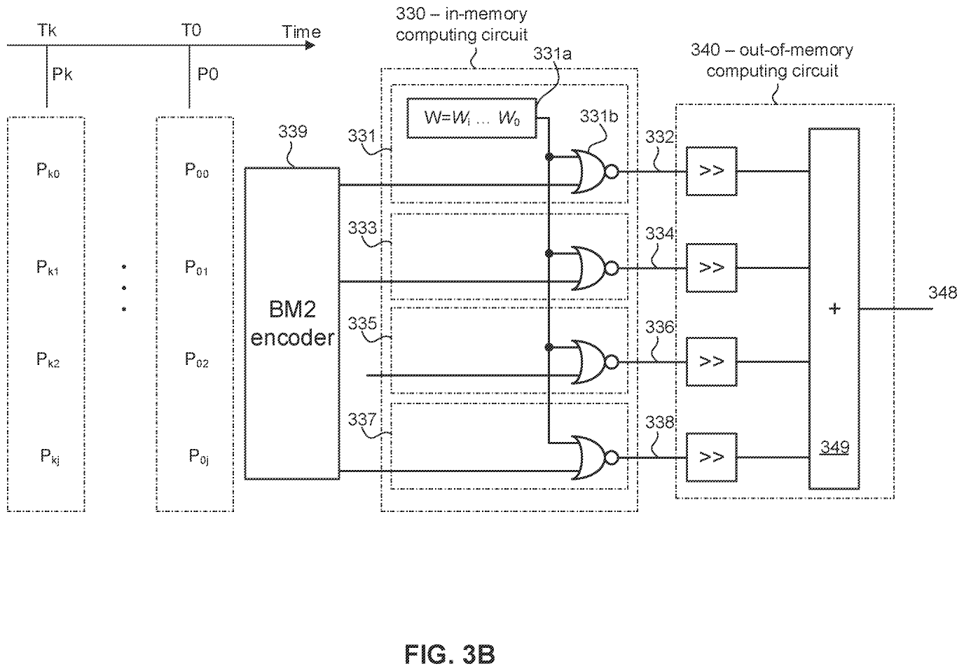

FIGS. 3A-3B are illustrations of IMC circuits to perform multiple-bit MAC operations for multiple input numbers, according to some embodiments. The input numbers can be P₀=P₀ⱼ . . . P₀₁P₀₀, P₁=P₁ⱼ . . . P₁₁P₁₀, . . . , Pₖ=Pₖⱼ . . . Pk₁Pₖ₀, and the weight number can be W=Wᵢ . . . W₁W₀. The IMC circuits perform MAC operations to calculate a product of W=Wᵢ . . . W₁W₀ with any of the input numbers, such as P₀, . . . , Pₖ, to derive P₀*W, . . . , Pₖ*W, and may further add the products together to derive a sum of product S=P₀*W+ . . . +Pₖ*W.

In some embodiments, as shown in FIG. 3A, an IMC circuit 310 is coupled to an out-of-memory computing block 320 to perform MAC operations to generate a product of the weight number W=Wᵢ . . . W₁W₀ and any of the input numbers, such as P₀, . . . , Pₖ. IMC circuit 310 and out-of-memory computing block 320 can be examples of IMC circuit 110 and out-of-memory computing block 120 shown in FIG. 1. IMC circuit 310 and out-of-memory computing block 320 are implemented based on the structure of circuit 210 and out-of-memory computing block 220, where only two bit numbers are involved.

In some embodiments, IMC circuit 310 can include. j bit-product circuits corresponding to the number of bits of input numbers, such as P₀, . . . , Pₖ. Some of the bit-product circuits are shown in FIG. 3A, including a bit-product circuit 311, a bit-product circuit 313, a bit-product circuit 315, and a bit-product circuit 317. Each bit-product circuit includes a set of memory cells to store the weight number W=Wᵢ . . . W₁W₀ and further includes a set of IMC cells to perform operations to generate a bit product. For example, bit-product circuit 311 can include a set 311a of memory cells to store the weight number W=Wᵢ . . . W₁W₀ and a set 311b of IMC cells having i IMC cells, where a bit of an input number, such as P₀₀ of input number P₀=P₀₁ . . . P₀₁P₀₀, . . . or Pₖ₀ of input number Pₖ=Pₖⱼ . . . Pₖ₁Pₖ₀, can be provided to bit-product circuit 311 to generate a bit-product 312. Similarly, bit-product circuit 313 can include a set of memory cells to store the weight number W=Wᵢ . . . W₁W₀ and a set of IMC cells to generate a bit-product 314; bit-product circuit 315 can include a set of memory cells to store the weight number W=Wᵢ . . . W₁W₀, and a set of IMC cells to generate a bit-product 316; and bit-product circuit 317 can include a set of memory cells to store the weight number W=Wᵢ . . . W₁W₀, and a set of IMC cells to generate a bit-product 318.

In some embodiments, for each bit-product circuit, out-of-memory computing block 320 can include a corresponding set of shifters coupled to the bit-product circuit. As shown in FIG. 3A, a set 321 of shifters are coupled to bit-product circuit 311 to shift bit-product 312, a set 323 of shifters are coupled to bit-product circuit 313 to shift bit-product 314, a set 325 of shifters are coupled to bit-product circuit 315 to shift bit-product 316, and a set 327 of shifters are coupled to bit-product circuit 317 to shift bit-product 318. The different sets of shifters can shift the corresponding bit-product by a different number of positions. Afterwards, a multiple-bit adder 329 can be coupled to the sets of shifters to generate a partial product 328, which may be part of or the complete product of an input number multiplied by the weight number W=Wᵢ . . . W₁W₀. The details of the operations are similar to the operations described for out-of-memory computing circuit 220, as described in FIG. 2A.

In some embodiments, at a first time instance T0, the bits of input number P₀, including P₀ⱼ, . . . ,P₀₁, P₀₀ can be provided in parallel at the same clock cycle to the corresponding bit-product circuits to generate multiple bit-products, such as bit-products 312, 314, 316, and 318. Afterwards, out-of-memory circuit 320 can generate the product W*P₀=Wᵢ . . . W₁W₀*P₀₁ . . . P₀₁P₀₀. Similarly, at a second time instance T1 after the first time instance T0, the bits of input number P₁, including P₁ⱼ, . . . , P₁₁P₁₀, can be provided in parallel at the same clock cycle to the corresponding bit-product circuits to generate multiple bit-products and can further be used to generate the product W*P₁=Wᵢ . . . W₁W₀*P₁ⱼ . . . P₁₁P₁₀. The rest of input numbers can be provided in sequence. For a time instance Tk, the bits of input number Pₖ, including Pₖ, . . . , Pₖ₁, Pₖ₀ can be provided in parallel at the same clock cycle to the corresponding bit-product circuits to generate multiple bit-products and can further be used to generate the product W*Pₖ=Wᵢ . . . W₁W₀*Pₖⱼ . . . Pₖ₁Pₖ₀. In some embodiments, the input numbers P₀, . . . , Pₖ can be provided at a double pumped speed.

In some embodiments, as shown in FIG. 3B, an IMC circuit 330 is coupled to an out-of-memory computing block 340 to perform MAC operations to generate a product of a weight number W=Wᵢ . . . W₁W₀ and any of the input numbers, such as P₀, . . . , Pₖ. IMC circuit 330 and out-of-memory computing block 340 can be examples of IMC circuit 110 and out-of-memory computing block 120 shown in FIG. 1. IMC circuit 310 and out-of-memory computing block 320 are implemented based on the structure of circuit 230 and out-of-memory computing block 240, where only two bit numbers are involved.

In some embodiments, IMC circuit 330 can include j bit-product circuits corresponding to the number of bits of input numbers, such as P₀, . . . , Pₖ. Some of the bit-product circuits are shown in FIG. 3B, including a bit-product circuit 331, a bit-product circuit 333, a bit-product circuit 335, and a bit-product circuit 337. Each bit-product circuit includes a set of memory cells to store the weight number W=Wᵢ . . . W₁W₀ and further includes a set of IMC cells to perform operations to generate a bit product. For example, bit-product circuit 331 can include a set 331a of memory cells to store the weight number W=Wᵢ . . . W₁W₀ and a set 331b of IMC cells having i IMC cells, where a bit of an input number, such as P₀₀ of input number P₀=P₀ⱼ . . . P₀₁P₀₀, . . . or Pₖ₀ of input number Pₖ=Pₖⱼ . . . Pₖ₁Pₖ₀, can be provided to bit-product circuit 331 to generate a bit-product 332. In addition, bit-product circuit 333 can share set 331a of memory cells with bit-product circuit 331 to access the weight number W=Wᵢ . . . W₁W₀ and further include a set of IMC cells to generate a bit-product 334; bit-product circuit 335 can share set 331a of memory cells with bit-product circuit 331 to access the weight number W=Wᵢ . . . W₁W₀ and further include a set of IMC cells to generate a bit-product 336; and bit-product circuit 337 can share set 331a of memory cells with bit-product circuit 331 to access the weight number W=Wᵢ . . . W₁W₀ and further include a set of IMC cells to generate a bit-product 338. In some embodiments, the bits of input number P₀=P₀ⱼ . . . P₀₁P₀₀, . . . or Pₖ₀ of input number Pₖ=Pₖⱼ . . . Pₖ₁Pₖ₀ can be selected from a set of Booth encoded bits of the input numbers generated by a Booth encoder 339 coupled to IMC circuit 330. In some embodiments, Booth encoder 339 can be located outside a memory circuit that includes IMC circuit 330.

In some embodiments, operations of out-of-memory computing block 340 can operate in the same way as described for out-of-memory computing block 320 shown in FIG. 3A to generate a product 348.

In some embodiments, at time instances 70 . . . 7k, input numbers P₀, P₁, . . . , Pₖ can be provided to the corresponding bit-product circuits to generate multiple bit-products, such as bit-products 332, 334, 336, and 338. Afterwards, as described for FIG. 3A, out-of-memory circuit 320 can generate the product W*P₀=Wᵢ . . . W₁W₀*P₀ⱼ . . . P₀₁P₀₀, W*P₁=Wᵢ . . . W₁W₀*P₁ⱼ . . . P₁₁P₁₀, and W*Pₖ=Wᵢ . . . W₁W₀*Pₖⱼ . . . Pₖ₁,Pₖ₀.

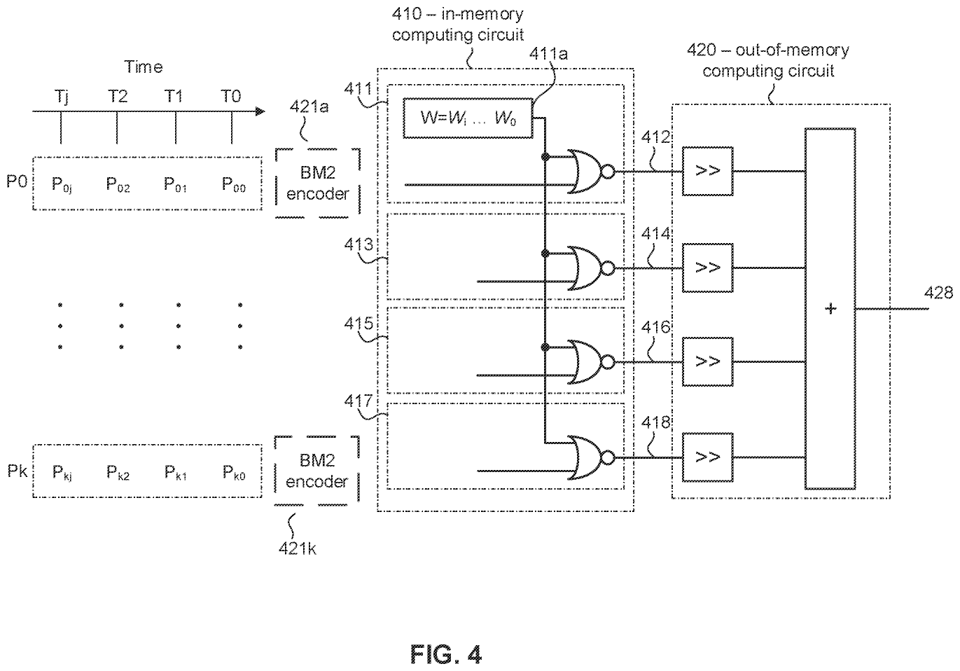

FIG. 4 is an illustration of IMC circuit 410 to perform multiple-bit MAC operations, according to some embodiments. IMC circuit 410 is coupled to an out-of-memory computing block 420 to perform MAC operations to generate a product of a weight number W=Wᵢ . . . W₁W₀ and any of the input numbers, such as P₀, . . . , Pₖ. IMC circuit 410 and out-of-memory computing block 420 can be examples of IMC circuit 110 and out-of-memory computing block 120 shown in FIG. 1. Bits of input numbers, such as P₀, . . . , Pₖ, can be provided to IMC circuit 410 in a bit-serial fashion. For example, for input number P₀=P₀ⱼ . . . P₀₁P₀₀, P₀₀ is provided at a time instance 70, P₀₁ is provided at a time instance T1, . . . , and P₀ⱼ is provided at a time instance Tj, where the time instance T0, T1, . . . Tj, can be consecutive clock cycles or determined based on other considerations.

In some embodiments, IMC circuit 410 can include k bit-product circuits corresponding to the number of input numbers, such as P₀, . . . , Pₖ. Some of the bit-product circuits are shown in FIG. 4, including a bit-product circuit 411, a bit-product circuit 413, a bit-product circuit 415, and a bit-product circuit 417. Each bit-product circuit includes a set of memory cells to store the weight number W=Wᵢ . . . W₁W₀ and further includes a set of IMC cells to perform operations to generate a bit product. For example, bit-product circuit 411 can include a set 411a of memory cells to store the weight number W=Wᵢ . . . W₁W₀ and a set 411b of IMC cells having i IMC cells, where bits of input number P₀, including P₀ⱼ . . . P₀₁P₀₀, P₀₀ can be provided to bit-product circuit 411 to generate a bit-product 412. In addition, bit-product circuit 413 can share set 411a of memory cells with bit-product circuit 411 to access the weight number W=Wᵢ . . . W₁W₀ and further include a set of IMC cells to generate a bit-product 412; bit-product circuit 415 can share set 411a of memory cells with bit-product circuit 411 to access the weight number W=Wᵢ . . . W₁W₀ and further include a set of IMC cells to generate a bit-product 416; and bit-product circuit 417 can share set 411a of memory cells with bit-product circuit 411 to access the weight number W=Wᵢ . . . W₁W₀ and further include a set of IMC cells to generate a bit-product 418. In some embodiments, the bits of input number P₀=P₀ⱼ . . . P₀₁P₀₀, . . . or bits of input number Pₖ=Pₖⱼ . . . Pₖ₁Pₖ₀ can be selected from a set of Booth encoded bits of the input numbers generated by a Booth encoder 421a . . . Booth encoder 421k coupled to a corresponding bit-product circuit for an input number. In some embodiments, Booth encoder 421a. Booth encoder 421k can be located outside a memory circuit that includes IMC circuit 410.

In some embodiments, operations of out-of-memory computing block 420 can operate in the same way as described for out-of-memory computing block 320 shown in FIG. 3A to generate a product 428.

In some embodiments, at time instances T0 . . . Tj, bits of input numbers P₀, P₁, . . . , Pₖcan be provided to the corresponding bit-product circuits to generate multiple bit-products, such as bit-products 412, 414, 416, and 418. Afterwards, similar to the operations described for FIG. 3A, out-of-memory circuit 420 can generate the product W*P₀=Wᵢ . . . W₁W₀*P₀ⱼ . . . P₀₁P₀₀, W*P₁=Wᵢ . . . W₁W₀*P₁ⱼ . . . P₁₁P₁₀, and W*Pₖ=Wᵢ . . . W₁W₀*Pₖⱼ . . . Pₖ₁Pₖ₀.

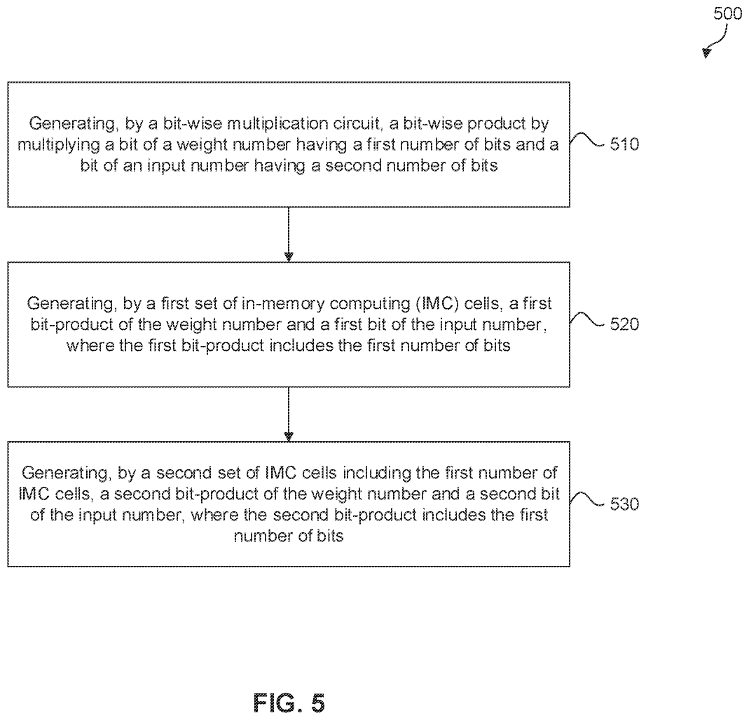

FIG. 5 is an illustration of a method 500 performing multiple-bit MAC operations by an IMC circuit, according to some embodiments. For illustrative purposes, the operations illustrated in method 500 will be described with reference to the IMC circuits shown in FIGS. 1, 2A-2C, 3A-3B, and 4. Other representations of IMC circuits are within the scope of the present disclosure. Also, additional operations may be performed between various operations of method 500 and may be omitted merely for clarity and ease of description. The additional operations can be provided before, during, and/or after method 500, in which one or more of these additional operations are briefly described herein. Moreover, not all operations may be needed to perform the disclosure provided herein. Additionally, some of the operations may be performed simultaneously or in a different order than shown in FIG. 5. In some embodiments, one or more other operations may be performed in addition to or in place of the presently-described operations.

At operation 510, a bit-wise multiplication circuit can generate a bit-wise product by multiplying a bit of a weight number having a first number of bits and a bit of an input number having a second number of bits. For example, as shown in FIG. 2A, a bit-wise multiplication circuit 202 is included in IMC cell 213b and coupled to memory cell 203 configured to store W₁ of the weight number W=W₁W₀. Bit-wise multiplication circuit 202 is a NOR gate to multiply P₁ of the input number P=P₁P₀ with W₁ of the weight number W=W₁W₀ to generate a bit-wise product P₁*W₁.

At operation 520, a first set of IMC cells can generate a first bit-product of the weight number and a first bit of the input number, where the first bit-product includes the first number of bits and a bit of the first bit-product includes a first bit-wise product generated by a first bit-wise multiplication circuit. For example, as shown in FIG. 2A, first set 211 of IMC cells have first IMC cell 211a and second IMC cell 211b and can generate first bit-product 221 of the weight number W=W₁W₀ and a first bit P₀ of the input number P=P₁P₀. Therefore, first bit-product 221 can have a value of (P₀*W₁)(P₀*W₀), where a bit (P₀*W₁) is a bit-wise product generated by a bit-wise multiplication circuit included in IMC cell 211b.

At operation 530, a second set of IMC cells including the first number of IMC cells can generate a second bit-product of the weight number and a second bit of the input number, where the second bit-product includes the first number of bits. A bit of the second bit-product includes a second bit-wise product generated by a second bit-wise multiplication circuit. For example, as shown in FIG. 2A, second set 213 of IMC cells can generate second bit-product 223 of the weight number W=W₁W₀ and a second bit P₁ of the input number P=P₁P₀, and having a value of (P₁*Wᵢ)(P₁*W₀). Second bit-product 223 can have a first bit 223a with a value of P₁*W₀, and a second bit 223b with a value of P₁*W₁.

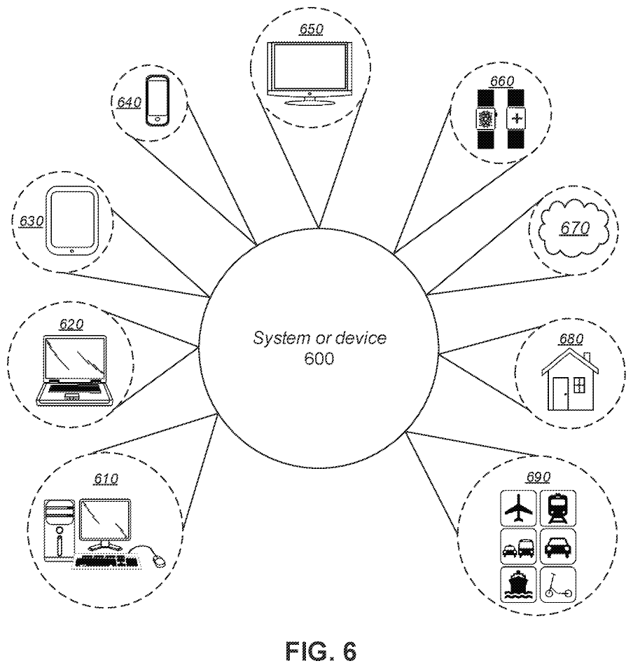

FIG. 6 is an illustration of exemplary systems or devices that can include the disclosed embodiments. System or device 600 can incorporate one or more of the disclosed embodiments in a wide range of areas. For example, system or device 600 can be implemented in one or more of a desktop computer 610, a laptop computer 620, a tablet computer 630, a cellular or mobile phone 640, and a television 650 (or a set-top box in communication with a television).

Also, system or device 600 can be implemented in a wearable device 660, such as a smartwatch or a health-monitoring device. In some embodiments, the smartwatch can have different functions, such as access to email, cellular service, and calendar functions. Wearable device 660 can also perform health-monitoring functions, such as monitoring a user's vital signs and performing epidemiological functions (e.g., contact tracing and providing communication to an emergency medical service). Wearable device 660 can be worn on a user's neck, implantable in user's body, glasses or a helmet designed to provide computer-generated reality experiences (e.g., augmented and/or virtual reality), any other suitable wearable device, and combinations thereof.

Further, system or device 600 can be implemented in a server computer system, such as a dedicated server or on shared hardware that implements a cloud-based service 670. System or device 600 can be implemented in other electronic devices, such as a home electronic device 680 that includes a refrigerator, a thermostat, a security camera, and other suitable home electronic devices. The interconnection of such devices can be referred to as the “Internet of Things” (IoT). System or device 600 can also be implemented in various modes of transportation 690, such as part of a vehicle's control system, guidance system, and/or entertainment system.

The systems and devices illustrated in FIG. 6 are merely examples and are not intended to limit future applications of the disclosed embodiments. Other example systems and devices that can implement the disclosed embodiments include portable gaming devices, music players, data storage devices, and unmanned aerial vehicles.

It is noted that references in the specification to “one embodiment,” “an embodiment,” “an example embodiment,” “exemplary,” etc., indicate that the embodiment described can include a particular feature, structure, or characteristic, but every embodiment can not necessarily include the particular feature, structure, or characteristic. Moreover, such phases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 5% of the value (e.g., ±1%, ±2%, ±3%, ±4%, ±5% of the value). These values are merely examples and are not intended to be limiting. The terms “about” and “substantially” can refer to a percentage of the values as interpreted by those skilled in relevant art(s) in light of the teachings herein. Furthermore, the terms “comprising,” “including,” “having,” and the like, as used with respect to embodiments of the present disclosure, are synonymous.

As used hereinafter, including the claims, the term “unit”, “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board, such as a motherboard, for example. By way of example and not limitation, “coupled” may mean two or more elements/devices cooperate and/or interact through one or more network linkages, such as wired and/or wireless networks. By way of example and not limitation, a computing apparatus may include two or more computing devices “coupled” on a motherboard or by one or more network linkages.

It is to be appreciated that the Detailed Description section, and not the Abstract of the Disclosure section, is intended to be used to interpret the claims. The Abstract of the Disclosure section may set forth one or more but not all possible embodiments of the present disclosure as contemplated by the inventor(s), and thus, are not intended to limit the subjoined claims in any way.

The foregoing disclosure outlines features of several embodiments so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the embodiments introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
a first set of in-memory computing (IMC) cells configured to generate a first bit-product of a weight number having a first number of bits and a first bit of an input number having a second number of bits, wherein a first IMC cell of the first set of IMC cells comprises a first bit-wise multiplication circuit configured to multiply a first bit of the weight number and the first bit of the input number; and
a second set of IMC cells including the first number of IMC cells configured to generate a second bit-product of the weight number and a second bit of the input number, wherein a second IMC cell of the second set of IMC cells comprises a second bit-wise multiplication circuit configured to multiply a second bit of the weight number and the second bit of the input number.

2. The device of claim 1, wherein the first IMC cell comprises a first memory cell configured to store the first bit of the weight number, and wherein the first IMC cell is coupled to a second memory cell configured to store the first bit of the input number.

3. The device of claim 2, wherein the first bit of the weight number stored in the first memory cell is coupled to an other IMC cell of the second set of IMC cells to provide the first bit of the weight number to the other IMC cell.

4. The device of claim 2, wherein one or more of the first memory cell and the second memory cell comprises a static random-access memory (SRAM) cell.

5. The device of claim 1, wherein the first bit-wise multiplication circuit comprises one or more of a NOR gate and a NAND gate.

6. The device of claim 1, wherein the first bit-wise multiplication circuit is configured to receive the first bit of the input number, and the second bit-wise multiplication circuit is configured to receive the second bit of the input number, and wherein the first bit of the input number and the second bit of the input number are selected from a set of Booth encoded bits of the input number.

7. The device of claim 1, further comprising a first set of shifters coupled to the first set of IMC cells and configured to shift the first bit-product by a first position to generate a first shifted bit-product; and
a second set of shifters coupled to the second set of IMC cells and configured to shift the second bit-product by a second position to generate a second shifted bit-product.

8. The device of claim 7, further comprising:
a multiple-bit adder coupled to the first set of shifters and the second set of shifters and configured to add the first shifted bit-product and the second shifted bit-product to generate a partial product of a product of the weight number and the input number.

9. The device of claim 1, wherein the input number is a first input number received by the first set of MC cells and the second set of IMC cells at a first time instance, and wherein:
the first set of IMC cells is further configured to generate a third bit-product of the weight number and a first bit of a second input number having the second number of bits received at a second time instance after the first time instance, wherein a third IMC cell of the first set of IMC cells comprises a third bit-wise multiplication circuit configured to multiply a third bit of the weight number and the first bit of the second input number; and
the second set of IMC cells is configured to generate a fourth bit-product of the weight number and a second bit of the second input number received at the second time instance, wherein a fourth IMC cell of the second set of IMC cells comprises a fourth bit-wise multiplication circuit configured to multiply a fourth bit of the weight number and the second bit of the second input number.

10. The device of claim 9, wherein the first set of IMC cells and the second set of IMC cells are configured to receive the first input number and the second input number, respectively, at a double pumped speed.

11. A memory circuit, comprising:
a set of memory cells configured to store a weight number having a first number of bits;
a control circuit configured to provide an input number to an in-memory computing (IMC) circuit, wherein the input number has a second number of bits; and
the in-memory computing (IMC) circuit comprising a matrix of IMC cells having a total number of IMC cells configured to receive in parallel the second number of bits of the input number and perform bit-wise multiplications in parallel, wherein an IMC cell of the matrix of IMC cells comprises a bit-wise multiplication circuit configured to multiply a first bit of the input number and a second bit of the weight number, and wherein the total number is a product of the first number and the second number.

12. The memory circuit of claim 11, wherein the matrix of IMC cells is configured to generate a second number of bit-products comprising a first bit-product and a second bit-product, the first bit-product being generated by a first set of IMC cells of the matrix of IMC cells for a product of the first bit of the input number multiplied with the weight number, and the second bit-product being generated by a second set of IMC cells of the matrix of IMC cells for a product of a second bit of the input number multiplied with the weight number.

13. The memory circuit of claim 12, wherein the memory circuit comprises:
a first set of shifters coupled to the first set of IMC cells and configured to shift the first bit-product by a first position to generate a first shifted bit-product; and
a second set of shifters coupled to the second set of IMC cells and configured to shift the second bit-product by a second position to generate a second shifted bit-product.

14. The memory circuit of claim 12, wherein the first bit of the input number and the second bit of the input number are selected from a set of Booth encoded bits of the input number.

15. The memory circuit of claim 13, wherein the first set of shifters and the second set of shifters are coupled to a multiple-bit adder configured to add the first shifted bit-product and the second shifted bit-product to generate a partial product of a product of the weight number and the input number.

16. The memory circuit of claim 11, wherein the IMC cell comprises a memory cell configured to store the second bit of the weight number, and wherein the IMC cell is coupled to an other memory cell configured to store the first bit of the input number.

17. The memory circuit of claim 16, wherein the memory cell comprises a static random-access memory (SRAM) cell.

18. The memory circuit of claim 11, wherein the bit-wise multiplication circuit comprises one or more of a NOR gate or a NAND gate.

19. A method, comprising:
generating, by a bit-wise multiplication circuit, a bit-wise product by multiplying a bit of a weight number having a first number of bits and a bit of an input number having a second number of bits;
generating, by a first set of in-memory computing (IMC) cells, a first bit-product of the weight number and a first bit of the input number, wherein the first bit-product comprises the first number of bits, and wherein a bit of the first bit-product comprises a first bit-wise product generated by a first bit-wise multiplication circuit; and
generating, by a second set of IMC cells comprising a first number of IMC cells, a second bit-product of the weight number and a second bit of the input number, wherein the second bit-product comprises the first number of bits, and wherein a bit of the second bit-product comprises a second bit-wise product generated by a second bit-wise multiplication circuit.

20. The method of claim 19, further comprising:
shifting, by a first set of shifters coupled to the first set of IMC cells, the first bit-product by a first position to generate a first shifted bit-product; and
shifting, by a second set of shifters coupled to the second set of IMC cells, the second bit-product by a second position to generate a second shifted bit-product; and
generating, by a multiple-bit adder coupled to the first set of shifters and the second set of shifters, a sum of the first shifted bit-product and the second shifted bit-product as a partial product of a product of the weight number and the input number.
